(19) United States
(12) Patent Application Publication
(10) Pub. No.: US 2021/0156354 A1
(43) Pub. Date: May 27, 2021

(54) LINEAR GENERATOR

(71) Applicant: Rohan Vishnubhai Patel, Bensalem, PA (US)

(72) Inventor: Rohan Vishnubhai Patel, Bensalem, PA (US)

(21) Appl. No.: 16/698,101

(22) Filed: Nov. 27, 2019

(51) Int. Cl. F03B 13/18; B63B 35/44; H02K 7/108; H02K 7/116; H02K 7/18

(52) U.S. Cl. CPC F03B 13/18; B63B 35/44; B63B 2035/4466; H02K 7/116; H02K 7/1876; H02K 7/108

(57) ABSTRACT

A linear gearbox with a linear shaft reciprocating inside its casing. The linear shaft moves in a reciprocating manner. The output shaft is operationally coupled to the input shaft. With the use of two one-way locking mechanisms & a few gears, the reciprocating movements of the linear shaft can be converted into one-directional rotational motion of the output shaft. The output shaft of the linear gearbox can be connected to a generator and spin the generator in a uni-rotational direction and generate electricity with a minimum energy loss. The linear gearbox generator can be used to harvest energy from ocean waves. Ocean waves' energy can be harvested into a unidirectional rotational motion coupled with a generator, which generates electricity.

### CROSS-REFERENCE TO RELATED APPLICATIONS

[symbol]

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

### Field of the Invention

The present disclosure relates generally to a linear generator. More so, the present invention relates to a linear generator that converts reciprocating movements of a linear shaft into one-directional rotational motion to generate electricity at an optimum efficiency.

### Description of the Related Art

Conventional linear generator mechanism converts reciprocating movements of a linear shaft into clockwise and counter clockwise movements, which is then coupled with a generator to generate electricity.

significant amount of mechanical energy is lost in the present configuration because every time the linear shaft changes its direction of linear movement; the generator's rotational direction also changes.

In light of the above mentioned drawbacks, there exists a need of a linear generator that converts reciprocating movements of linear shaft into one-directional rotational movements that optimize energy generation efficiency.

### BRIEF SUMMARY OF THE INVENTION

A primary object of the disclosure is to provide liner generator which converts reciprocating movements of a linear shaft into one-directional rotational motion.

another object of the present disclosure is use of this linear generator to harvest wave energy.

### DESCRIPTION OF THE DRAWINGS

having thus described the disclosure in general terms, reference will now be made to the accompanying figure, wherein:

FIG. 1 illustrates a linear generator, in accordance with an embodiment of the present disclosure; and

FIG. 2 illustrates the linear generator being used for harvesting energy from ocean wave, in accordance with an embodiment of the present disclosure.

FIG. 3 illustrates a return mechanism.

It should be noted that the accompanying figure are intended to present illustrations of exemplary embodiments of the present disclosure. This figure is not intended to limit the scope of the present disclosure. It should also be noted that accompanying figure is not necessarily drawn to scale.

### DETAILED DESCRIPTION OF THE INVENTION

Reference will now be made in detail to selected embodiments of the present disclosure in conjunction with accompanying figures. The embodiments described herein are not intended to limit the scope of the disclosure, and the present disclosure should not be construed as limited to the embodiments described. This disclosure may be embodied in different forms without departing from the scope and spirit of the disclosure. It should be understood that the accompanying figure is intended and provided to illustrate embodiments of the disclosure described below and are not necessarily drawn to scale. In the drawing, like numbers refer to like elements throughout, and thicknesses and dimensions of some components may be exaggerated for providing better clarity and ease of understanding.

It should be noted that the terms “first”, “second”, and the like, herein do not denote any order, ranking, quantity, or importance, but rather are used to distinguish one element from another. Further, the terms “a” and “an” herein do not denote a limitation of quantity, but rather denote the presence of at least one of the referenced item.

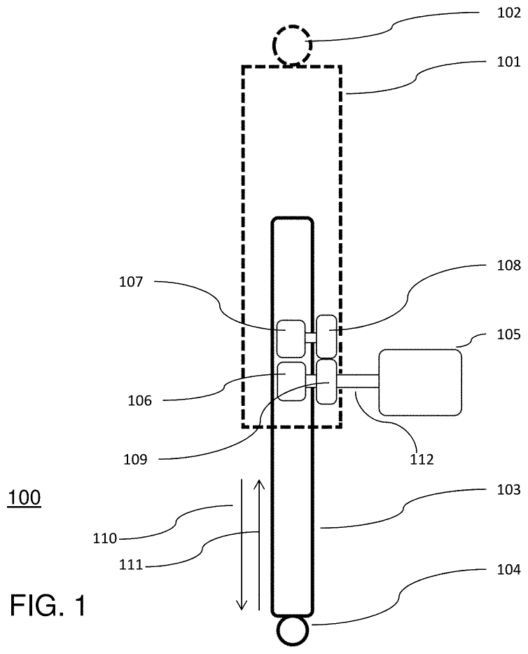

FIG. 1 illustrates a linear generator, in accordance with an embodiment of the present disclosure. The linear generator 100 is shown to have a geared liner shaft 103 in a casing 101. The geared liner shaft 103 has an attachment point 104 and the casing 101 has a body attachment point 102. The geared liner shaft 103 is operationally coupled to a generator 105 through a first set of gears 106 and a second set of gears 107, 108 and 109. The geared liner shaft 103 reciprocates in direction 110 & 111.

When the geared liner shaft 103 moves outward casing 101 in direction 110, the mechanical energy of the geared liner shaft 103 is transferred through the first set of gears 106 which spins in counter-clockwise direction looking at the gear 106 from the left side of generator 100 shown in the FIG. 1. The counter-clockwise spinning gear 106 is coupled with an input shaft 112 of the generator 105 with a one-way clutch mechanism (not shown) that spins the generator 105 in counter-clockwise direction. The first set of gears 106 are connected to an input shaft 112 of the generator 105 though one-way clutch (not shown) to transfer only counter-clockwise direction of the gear 106 to the input shaft 112 of the generator 105.

When the geared liner shaft 103 returns back into the casing 101 in direction 111, the first set of gear 106 spins clock-wise but since the gear 106 is coupled with input shaft 112 of the generator 105 with one-way clutch; the gear 106 spin freely without transferring any rotational motion to the input shaft 112 of the generator 105. During the retraction of the linear shaft 103 into the casing 101 the mechanical energy flows through the second set of gears 107, 108 and 109 to the input shaft 112 of the generator 105. During this mechanical energy transfer the gear 107 spins clockwise. The gear 107 is operationally connected to the gear 108, which also spins clockwise too. Clockwise spinning gear 108 spins the gear 109 counter-clockwise, which then transfers its rotational motion by spinning the input shaft 112 of the generator 105 counter-clockwise. Use of at least one one-way lockup clutch between the gear 107 and the input shaft 112 of the generator 105 enables transfer of only counter-clockwise motion to the input shaft 112 of the generator 105.

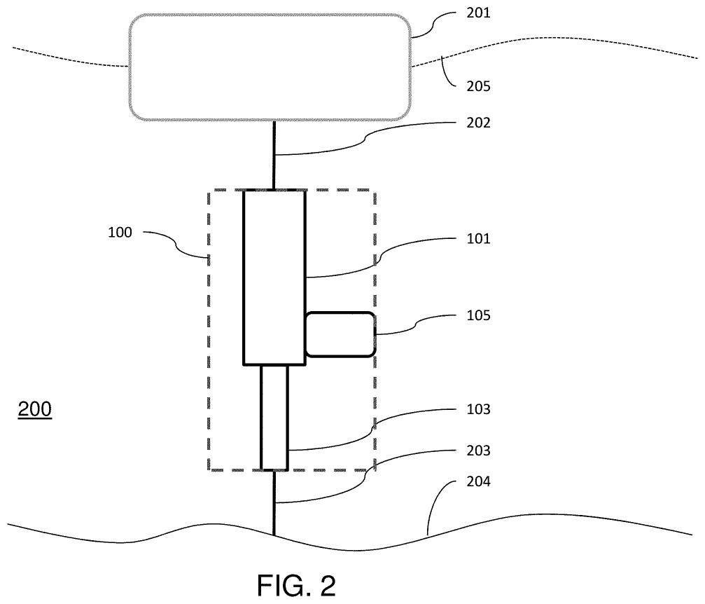

FIG. 2 illustrates the linear generator 100 for harvesting ocean wave energy, in accordance with an embodiment of the present disclosure. The linear generator 100 is shown to include the casing 101, the geared liner shaft 103 and the generator 105 for explanation purpose. The linear generator 100 is connected to a buoyant structure 401 floating at an ocean surface 205. The linear generator 100 is connected through a cable 402 to tether the casing 101 with the buoyant structure 401. Other end of the linear generator 100 is secured to an ocean bed 204 through a cable 403. The cable 403 tethers the shaft attachment point 104 to the ocean bed 204.

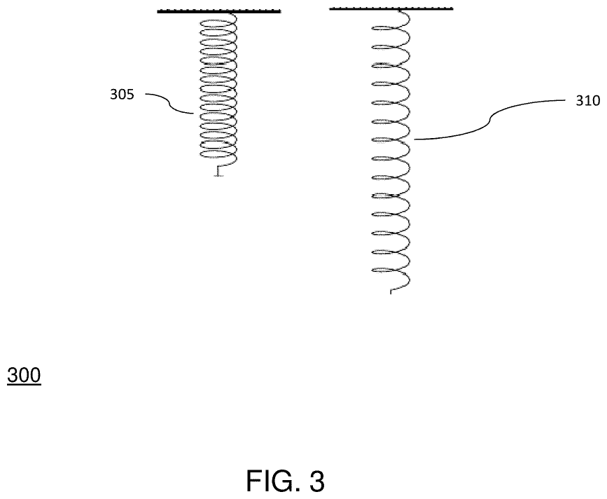

FIG. 3 illustrates the return mechanism 300. The return mechanism pulls the linear shaft back into the geared liner shaft 103 into the outward casing 101.

The linear generator an energy efficient generator due to unidirectional spinning of the generator. In addition, to unidirectional spinning of the generator provides for long life of the gears. Moreover, the linear generator operates under lower stress.

What is claimed is:

1. A linear generator comprising:
a body, a linear shaft, an input shaft of a generator, a generator, first set of gear and second set of gears, at least two one-way clutches
the body comprising an outer structure;
the linear shaft capable of a reciprocating motion, wherein the linear shaft reciprocates between a first position and a second position, wherein the first position is a position where the linear shaft is most inward the body, wherein the second position is most outward the body, wherein the linear shaft has a geared surface;
wherein the first set of gear is coupled with the linear shaft and present on the input shaft of the generator, wherein the first set of gear is coupled to the input shaft of the generator by first of the at least two one-way clutches, wherein the first set of gear is configured to spin the input shaft one the generator when the linear shaft moves into one direction;
wherein the second set of gears has three gears, wherein first of the three gears is coupled with the linear shaft and is connected to second of the three gears with a shaft, wherein the second of the three gears is coupled to third of the three gears, wherein the third of the three gears spins in the opposite direction of the second of the three gears, wherein the first of the three gears is coupled with the input shaft of the generator with a second of the at least two one-way clutches, wherein the third of the three gears is present onto the input shaft of the generator, wherein the second set of three gears spins the input shaft of the generator in the same direction when the input shaft moves into the opposite direction,
wherein at least one generator being operationally coupled to the linear shaft, wherein at least one generator is actuated by the linear shaft.

2. The linear generator claimed in claim 1, wherein the linear shaft moves from the first position to the second position during actuation.

3. The linear generator claimed in claim 1, wherein the linear shaft moves from the second position to the first position during return motion of the linear shaft.

4. The linear generator claimed in claim 1 further comprising a return mechanism, wherein the return mechanism is configured to bring the linear shaft back into the first position from the second position, wherein the first position is a position where the linear shaft is most inward the body.

5. (canceled)

6. (canceled)

7. (canceled)

8. The linear generator claimed in claim 1 further comprising a gear box, wherein the linear shaft is operationally coupled to the at least one generator using the gear box.

9. The linear generator as claimed in claim 1, wherein the linear generator is used to harvest energy of ocean waves.

10. The linear generator claimed in claim 9, wherein the linear generator has a first end and a second end, wherein at least one end is attached to an anchor by a first cable, wherein the remaining end is attached to a float by a second cable, wherein the anchor is secured to ocean bed, wherein the float floats on the ocean surface.

11. (canceled)

12. (canceled)

13. (canceled)

14. (canceled)

15. (canceled)

16. (canceled)

17. (canceled)

18. (canceled)

19. (canceled)

20. (canceled)

21. A linear generator comprising:
a body, a linear shaft, a return mechanism, a generator, at least two one-way clutches;
wherein the body comprising an outer structure;
wherein the linear shaft capable of a reciprocating motion, wherein the linear shaft reciprocates between a first position and a second position, wherein the first position is a position where the linear shaft is most inward the body, wherein the second position is most outward the body, wherein the linear shaft has a geared surface;
wherein the first set of gear is coupled with the linear shaft and operationally coupled to the input shaft of the generator with first of the at least two one-way clutches;
wherein the second set of gear is coupled with the linear shaft and operationally coupled to the input shaft of the generator with the second of the at least two one-way clutches, wherein the first set of gear and the second set of gear together configured to harvest reciprocating motion of the linear shaft into one directional rotational motion of the input shaft of the generator;
wherein the return mechanism is configured to pull the linear shaft back into the first position, wherein the return mechanism stores mechanical energy when the linear shaft is pulled outward from the first position to the second position and uses the stored energy to spin the generator while returning back into the first position;
wherein the generator being operationally coupled to the linear shaft, wherein the first set of gear and the second set of gear converts reciprocating movements of the linear shaft into unidirectional rotation of the input shaft of the generator.

22. The linear generator claimed in claim 21 further comprising a gear box, wherein the linear shaft is operationally coupled to the at least one generator using the gear box.

23. The linear generator as claimed in claim 21, wherein the linear generator is used to harvest energy of ocean waves.

24. The linear generator claimed in claim 21, wherein the linear generator has a first end and a second end, wherein at least one end is attached to an anchor by a first cable, wherein the remaining end is attached to a float by a second cable, wherein the anchor is secured to ocean bed, wherein the float floats on the ocean surface.
